(19) United States
(12) Patent Application Publication
(10) Pub. No.: US 2008/0091675 A1
(43) Pub. Date: Apr. 17, 2008

(54) Methods and apparatuses for modifying a search term utilized to identify an electronic mail message

(76) Inventors: Wilson Chu, San Lorenzo, CA (US); Elena Vitorino, San Jose, CA (US); Jimmy Huang, San Jose, CA (US); Richard Iijima, Fremont, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/549,557

(22) Filed: Oct. 13, 2006

(51) Int. Cl. G06F 17/30

(52) U.S. Cl. 707/6

(57) ABSTRACT

In one embodiment, the methods and apparatuses detect a message; detect an original search term; search for a match between the original search term and a term within the message; and selectively modify the original search term based on a number of matches.

### FIELD OF INVENTION

The present invention relates generally to recognizing terms and, more particularly, to modifying a search term utilized to identify an electronic mail message.

### BACKGROUND

Electronic mail applications such as Outlook® and Tiger Mail® allow users to search for specific electronic mail messages by searching for a term or key word. The user can search for the term or key word in the body of the message, the subject line of the message, the sender, and/or the recipient. Further, the user can search for messages by date sent.

### SUMMARY

In one embodiment, the methods and apparatuses detect a message; detect an original search term; search for a match between the original search term and a term within the message; and selectively modify the original search term based on a number of matches.

### BRIEF DESCRIPTION OF THE DRAWINGS

The accompanying drawings, which are incorporated in and constitute a part of this specification, illustrate and explain one embodiment of the methods and apparatuses for modifying a search term utilized to identify an electronic mail message.

In the drawings,

FIG. 1 is a diagram illustrating an environment within which the methods and apparatuses for modifying a search term utilized to identify an electronic mail message are implemented;

FIG. 2 is a simplified block diagram illustrating one embodiment in which the methods and apparatuses for modifying a search term utilized to identify an electronic mail message are implemented;

FIG. 3 is a simplified block diagram illustrating a system, consistent with one embodiment of the methods and apparatuses selectively controlling a remote device;

FIG. 4 is an exemplary record for use with the methods and apparatuses for modifying a search term utilized to identify an electronic mail message; and

FIG. 5 is a flow diagram consistent with one embodiment of the methods and apparatuses for modifying a search term utilized to identify an electronic mail message.

### DETAILED DESCRIPTION

The following detailed description of the methods and apparatuses for modifying a search term utilized to identify an electronic mail message refers to the accompanying drawings. The detailed description is not intended to limit the methods and apparatuses for modifying a search term utilized to identify an electronic mail message. Instead, the scope of the methods and apparatuses for modifying a search term utilized to identify an electronic mail message is defined by the appended claims and equivalents. Those skilled in the art will recognize that many other implementations are possible, consistent with the present invention.

References to a device include a desktop computer, a portable computer, a personal digital assistant, a video phone, a landline telephone, a cellular telephone, and a device capable of receiving/transmitting an electronic signal.

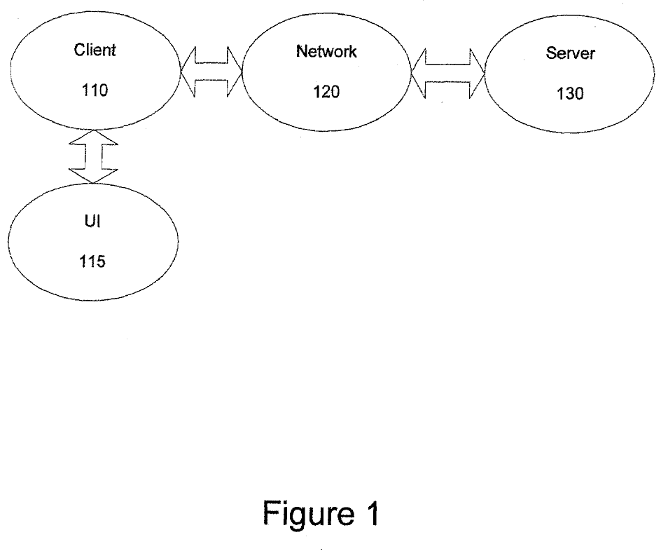

FIG. 1 is a diagram illustrating an environment within which the methods and apparatuses for modifying a search term utilized to identify an electronic mail message are implemented. The environment includes an electronic device 110 (e.g., a computing platform configured to act as a client device, such as a computer, a personal digital assistant, and the like), a user interface 115, a network 120 (e.g., a local area network, a home network, the Internet), and a server 130 (e.g., a computing platform configured to act as a server).

In one embodiment, one or more user interface 115 components are made integral with the electronic device 110 (e.g., keypad and video display screen input and output interfaces in the same housing such as a personal digital assistant. In other embodiments, one or more user interface 115 components (e.g., a keyboard, a pointing device such as a mouse, a trackball, etc.), a microphone, a speaker, a display, a camera are physically separate from, and are conventionally coupled to, electronic device 110. In one embodiment, the user utilizes interface 115 to access and control content and applications stored in electronic device 110, server 130, or a remote storage device (not shown) coupled via network 120.

In accordance with the invention, embodiments of dynamically enforcing privileges during a data collaboration session below are executed by an electronic processor in electronic device 110, in server 130, or by processors in electronic device 110 and in server 130 acting together. Server 130 is illustrated in FIG. 1 as being a single computing platform, but in other instances are two or more interconnected computing platforms that act as a server.

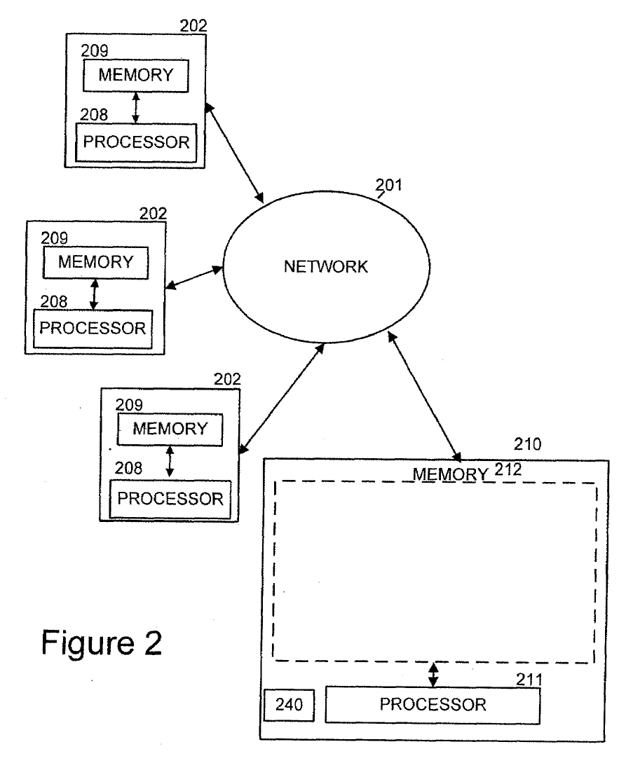

FIG. 2 is a simplified diagram illustrating an exemplary architecture in which the methods and apparatuses for modifying a search term utilized to identify an electronic mail message are implemented. The exemplary architecture includes a plurality of electronic devices 202, a server device 210, and a network 201 connecting electronic devices 202 to server 210 and each electronic device 202 to each other. The plurality of electronic devices 202 are each configured to include a computer-readable medium 209, such as random access memory, coupled to an electronic processor 208. Processor 208 executes program instructions stored in the computer-readable medium 209. In one embodiment, a unique user operates each electronic device 202 via an interface 115 as described with reference to FIG. 1.

The server device 130 includes a processor 211 coupled to a computer-readable medium 212. In one embodiment, the server device 130 is coupled to one or more additional external or internal devices, such as, without limitation, a secondary data storage element, such as database 240.

In one instance, processors 208 and 211 are manufactured by Intel Corporation, of Santa Clara, Calif. In other instances, other microprocessors are used.

In one embodiment, the plurality of client devices 202 and the server 210 include instructions for a customized application for modifying a search term utilized to identify an electronic mail message. In one embodiment, the plurality of computer-readable media 209 and 212 contain, in part, the customized application. Additionally, the plurality of client devices 202 and the server 210 are configured to receive and transmit electronic messages for use with the customized application. Similarly, the network 210 is configured to transmit electronic messages for use with the customized application.

One or more user applications are stored in media 209, in media 212, or a single user application is stored in part in one media 209 and in part in media 212. In one instance, a stored user application, regardless of storage location, is made customizable based on dynamically enforcing privileges during a data collaboration sessions determined using embodiments described below.

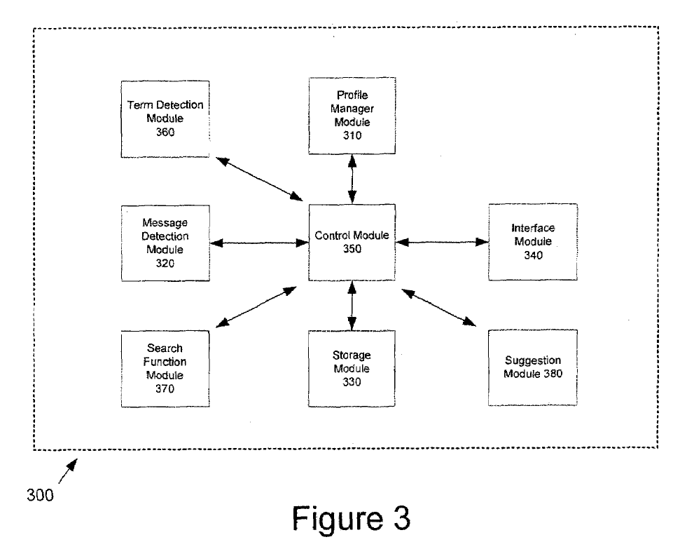

FIG. 3 illustrates one embodiment of a system 300. In one embodiment, the system 300 is embodied within the server 130. In another embodiment, the system 300 is embodied within the electronic device 110. In yet another embodiment, the system 300 is embodied within both the electronic device 110 and the server 130.

In one embodiment, the system 300 includes a profile manager module 310, a message detection module 320, a storage module 330, an interface module 340, a control module 350, a term detection module 360, a search module 370, and a suggestion module 380.

In one embodiment, the control module 350 communicates with the profile manager module 310, the message detection module 320, the storage module 330, the interface module 340, the term detection module 360, the search module 370, and the suggestion module 380. In one embodiment, the control module 350 coordinates tasks, requests, and communications between the profile manager module 310, the message detection module 320, the storage module 330, the interface module 340, the term detection module 360, the search module 370, and the suggestion module 380.

In one embodiment, the profile manager module 310 organizes and tracks the profiles. In one embodiment, each profile corresponds to a specific user account associated with a particular electronic message account. In another embodiment, each profile corresponds to a plurality of electronic message accounts. For example, the plurality of electronic message accounts may belong to a single company. In another embodiment, the plurality of electronic message accounts may belong to multiple companies.

In one embodiment, the message detection module 320 detects and identifies the electronic mail message. In one embodiment, the message detection module 320 detects electronic messages that are transmitted through the network 120. In one embodiment, the message detection module 320 is capable of detecting electronic messages that are sent or received by any of the user accounts associated with the profile.

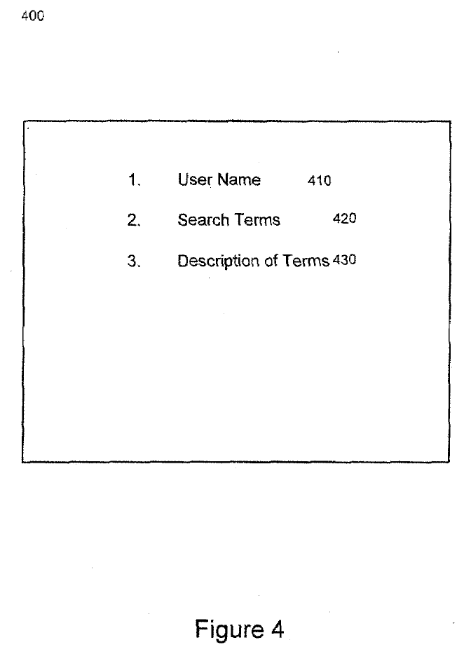

In one embodiment, the storage module 330 stores a record including a profile associated with the each device, user, electronic mail account, or group of electronic mail accounts. An exemplary profile is shown in a record 400 within FIG. 4.

In one embodiment, the storage module 330 stores electronic mail messages. Further, the storage module 330 is configured to store various terms and descriptions corresponding to a search term. In one embodiment, a description of the search term includes synonyms and equivalents of the search term.

In one embodiment, the storage module 330 is configured to store an equivalent search term that corresponds to the search term.

In one embodiment, the interface module 340 detects electronic messages transmitted between accounts and user interaction from a device through the network 120.

In one embodiment, the interface module 340 displays suggested alternatives to the terms being searched within an electronic message. In another embodiment, the interface module 340 allows definitions to be applied to new terms associated with the content from an electronic message.

In one embodiment, the term detection module 360 is configured to detect a search term that is utilized to find the same term within the electronic mail message.

In one embodiment, the search module 370 is configured to find a term within the electronic mail message that matches the search term.

In one embodiment, the suggestion module 380 is configured to suggest equivalent terms associated with the search term.

In one embodiment, the equivalent terms are utilized if there are not a sufficient number of matches to the search term. The equivalent terms expand the scope of the original search term. In one embodiment, the equivalent terms include synonyms of the search term. In another embodiment, the equivalent terms include phonetically similar sounding terms corresponding with the search term. In yet another embodiment, the equivalent terms include misspellings of the search term. In yet another embodiment, the equivalent terms include abbreviations of the search term. In this instance, the equivalent terms are used in conjunction with the original search term to broaden the original search term. For example, for a match to occur, the original search term or the equivalent search terms are found within the same message.

In another embodiment, the equivalent terms are utilized if there are too many matches to the search term. The equivalent terms reduce the scope of the original search term. In one embodiment, the equivalent terms include synonyms of the search term that further provide context of the original search term. In this instance, the equivalent terms are used in conjunction with the original search term to further limit the original search term. For example, for a match to occur, the original search term and the equivalent search terms are found within the same message.

The system 300 in FIG. 3 is shown for exemplary purposes and is merely one embodiment of the methods and apparatuses for modifying a search term utilized to identify an electronic mail message. Additional modules may be added to the system 300 without departing from the scope of the methods and apparatuses for modifying a search term utilized to identify an electronic mail message. Similarly, modules may be combined or deleted without departing from the scope of the methods and apparatuses for modifying a search term utilized to identify an electronic mail message.

FIG. 4 illustrates an exemplary record 400 for use with the methods and apparatuses for modifying a search term utilized to identify an electronic mail message. In one embodiment, the record 400 illustrates an exemplary record associated with managing terms within messages and tracking the definitions of these terms.

In one embodiment, there are multiple records such that each record 400 is associated with a particular user, device, or group of users. Further, each device or user may correspond with multiple records wherein each record 400 is associated with a particular profile associated with the device.

In one embodiment, the record 400 includes a user name field 410, a search terms field 420, and a description of terms field 430. In one embodiment, the record 400 resides within the client 110. In another embodiment, the record 400 resides within the server 130.

In one embodiment, the user name field 410 includes information related to a user, a device, or group. For example, the user name field 410 may include a company name that includes the group of accounts, a department associated with multiple accounts, and a single account associated with a user.

In one embodiment, the search terms field 420 includes terms that are searched for within an electronic mail message associated with the individual or group identified within the user name field 410. The search terms may include references to information within a sender field, a recipient field, a carbon copy field, a subject line, a date sent field, a date received field, and a body area. Further, the search terms may also be indexed and stored within the search terms field 420.

In one embodiment, the description of terms field 430 includes descriptions associated with the particular search terms referenced in the search terms field 420. In one embodiment, the description includes synonyms of the search term. In another embodiment, the description includes words sounding the same or similar to the search term. In yet another embodiment, the description includes words that describe the search term.

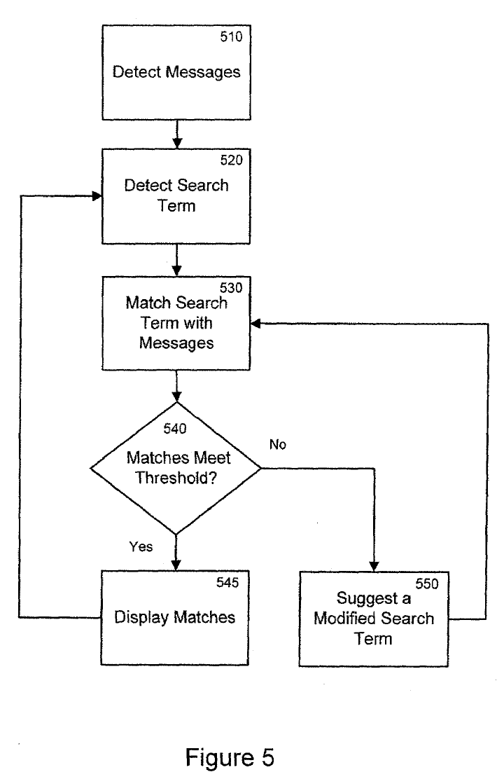

The flow diagram as depicted in FIG. 5 is one embodiment of the methods and apparatuses for modifying a search term utilized to identify an electronic mail message. The blocks within the flow diagram can be performed in a different sequence without departing from the spirit of the methods and apparatuses for modifying a search term utilized to identify an electronic mail message. Further, blocks can be deleted, added, or combined without departing from the spirit of the methods and apparatuses for modifying a search term utilized to identify an electronic mail message.

The flow diagram in FIG. 5 illustrates finding a search term within a message according to one embodiment of the invention.

In Block 510, a message is detected. In one embodiment, the message is an electronic mail message. In another embodiment, multiple messages are detected.

In one embodiment, the messaged detected correspond to a single user. In another embodiment, the messages detected correspond to multiple users within an organization.

In Block 520, a search term is identified for identifying within the detected message. In one embodiment, the search term is a single word. In another embodiment, the search term is a group of words.

In Block 530, the search term is matched with a corresponding term within the detected message. In one embodiment, the search term is matched with a corresponding term within the sender field, the recipient field, the subject field, and/or the body.

In Block 540, if the number of messages matching the search term falls within the predetermined limits, then the matched messages are displayed in Block 545. In one embodiment, the predetermined limits include both an upper limit and a lower limit. For instance, the lower limit may be no matched messages, and the upper limit may be 20 matched messages. However, the lower limit and the upper limit may be set to a variety of values. In another embodiment, the predetermined limits may include only an upper limit or a lower limit.

After the matched messages are displayed according to the Block 545, additional search terms are detected according to the Block 520.

If the number of messages matching the search term falls outside the predetermined limits, then a modified search term is suggested in Block 550.

In one embodiment, when the number of messages matching the search term exceeds the upper predetermined limit, then an additional term is suggested to be added to the original search term to form the modified search term. The additional term is an additional limitation that narrows the modified search term. By adding the additional term, the number of messages matching the modified search term may be reduced. In this example, each of the terms within the modified search term is matched within a given message for the message to be considered a match. In one instance, if the original search term was “apple” and the number of matched messages exceeded the upper limit, then an additional term “computer” can be added to the modified search term to further define that the term Apple® refers to the computer rather than a fruit.

In one embodiment, when the number of messages matching the search term falls below the lower predetermined limit, then an additional term is suggested to be added to the original search term to form the modified search term. In this case, the additional term broadens the modified search term. By adding the additional term, the number of messages matching the modified search term may be increased in this embodiment. In this example, any of the terms within the modified search term are matched within a given message for the message to be considered a match. In one instance, if the original search term included “data” and the number of matched messages fell below the lower limit, then an additional term “audio” can be added to the modified search term to further expand the term “data” and also include references to the term “audio”.

In embodiment, the additional terms can be synonyms of the original term, words that sound similar to the original term, and the like.

The foregoing descriptions of specific embodiments of the invention have been presented for purposes of illustration and description. The invention may be applied to a variety of other applications.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed:

1. A method comprising:
detecting a message;
detecting an original search term;
searching for a match between the original search term and a term within the message; and
selectively modifying the original search term based on a number of matches.

2. The method according to claim 1 further comprising displaying the match between the original search term and the term within the message.

3. The method according to claim 1 further comprising detecting an upper threshold limit wherein modifying the original search term occurs when the number of matches exceeds the upper limit threshold.

4. The method according to claim 1 further comprising detecting a lower threshold limit wherein modifying the original search term occurs when the number of matches falls below the lower limit threshold.

5. The method according to claim 1 wherein selectively modifying the original search term Comprises narrowing the search term and forming a narrowed search term.

6. The method according to claim 5 further comprising adding an additional term to limit the original search term.

7. The method according to claim 1 wherein selectively modifying the original search term comprises broadening the original search term and forming a broadened search term.

8. The method according to claim 7 further comprising providing an alternative search term in addition to the original search term for forming the broadened search term.

9. The method according to claim 8 wherein the alternative search term is a synonym of the original search term.

10. The method according to claim 8 wherein the alternative search term is pronounced like of the original search term with a different spelling.

11. The method according to claim 8 wherein the alternative search term is a misspelling of the original search term.

12. The method according to claim 8 wherein the alternative search term is an abbreviation of the original search term.

13. The method according to claim 8 wherein the alternative search term is an equivalent of the original search term.

14. The method according to claim 1 wherein the message is a textual representation.

15. The method according to claim 1 wherein the message is a graphical representation.

16. A method comprising:
detecting a message;
detecting an original search term;
searching for a match between the original search term and a term within the message; and
selectively adding an alternative search term to the original search term based on a number of matches;

17. The method according to claim 16 wherein the alternative search term is a synonym of the original search term.

18. The method according to claim 16 wherein the alternative search term is pronounced like of the original search term with a different spelling.

19. The method according to claim 16 wherein the alternative search term is a misspelling of the original search term.

20. The method according to claim 16 wherein the alternative search term is an abbreviation of the original search term.

21. The method according to claim 16 wherein the alternative search term is an equivalent of the original search term.

22. A system, comprising:
a message detection module configured to detect a message;
a search function module configured to detect an original search term within the message; and
a suggestion module configured to suggest an alternative search term based on the original search term wherein the alternative search term is utilized within a modified search term.

23. The system according to claim 22 further comprising a storage module configured to store the original search term and the alternative search term.

24. The system according to claim 22 wherein the modified search term is broader than the original search term.

25. The system according to claim 22 wherein the modified search term is narrower than the original search term.
